(19) United States
(12) Patent Application Publication
(10) Pub. No.: US 2012/0174006 A1
(43) Pub. Date: Jul. 5, 2012

(54) SYSTEM, METHOD, APPARATUS AND COMPUTER PROGRAM FOR GENERATING AND MODELING A SCENE

(75) Inventors: Jason BROWNELL, San Francisco, CA (US); Matthew ROTHENBERG, Maplewood, NJ (US)

(73) Assignee: SCENEMACHINE, LLC, Maplewood, NJ (US)

(21) Appl. No.: 13/175,845

(22) Filed: Jul. 2, 2011

Related U.S. Application Data
(60) Provisional application No. 61/360,999, filed on Jul. 2, 2010.

(51) Int. Cl. G06F 3/048

(52) U.S. Cl. 715/764

(57) ABSTRACT

A system, method, apparatus and computer program utilize unique algorithms to identify relationships among user generated nodes of data to present an objective and dynamic visual computer model of a socio-cultural “scene.” Users enter information through a user interface, based on uniquely structured taxonomies, and the unique algorithms analyze the input information to identify relationships among the input information and then the identified relationships are presented or displayed in a dynamic graphical format. The “scenes” denote voluntary social groupings of individuals who were in geographical proximity at the same period of time and shared experiences based on an affinity to or involvement with a common cultural experience, not based upon any formal membership in an institution.

This application is a Non-Provisional Application of U.S. Provisional Application No. 61/360,999, filed Jul. 2, 2010, the entire contents of which are hereby incorporated by reference.

### BACKGROUND OF THE INVENTION

1. Field of the Invention

The present invention relates to a system, method, apparatus and computer program for creating a dynamic visual model of a “scene” (e.g., a socio-cultural environment or social milieu based on a common or shared experience, interest or physical presence) by performing algorithmic analysis on one or more relationships between information, which may include historical, current, and/or user or computer generated information, and which information may be stored in a storage medium or accessed through a computer network, device or system. The algorithms analyze, identify and provide information, preferably in a graphical display format, concerning various connections among nodes of information that constitute a cultural scene, such as, a music scene, which is generated by the algorithmic analysis of information on bands, band members, musical concerts, venues, geography, time, fan experiences and opinions, etc., for example.

2. Description of the Related Art

Various websites and information sources relating to cultural scenes are known in the art and provide some information and analysis concerning cultural scenes. These known cultural scene resources are lacking in many aspects described below, but most notably fail to take into account actual real-world cultural scenes, such as music scenes, and further fail to identify unique relationships across a broad spectrum of information, people and experiences, and also fail to provide users with a dynamic interactive experience relating to a cultural scene based on the unique relationships identified by algorithmic analysis.

In the discussion of the conventional cultural scene resources below, music scenes will be used as a non-limiting example.

The World of Music project at Stanford University, dating from 2004, displays a navigable, interactive graph of musical artists and uses algorithms to analyze relational data. However, this system:
Takes no account of musical scenes.
Only considers musical artists and performers, and no other types of participants.
Is based entirely on subjective ratings by music “fans”, and makes no account for verifiable facts or events.

The commercial companies Gracenote and All Music, and the non-profit MusicBrainz, each offer a database of musical artists and musical works where relationships can be navigated through hyperlinks. However, all of these systems:
Take no account of musical scenes.
Are primarily focused on major label recordings and the artists who produce them; no other participants except those directly involved in creating recordings are considered.
Make extensive use of the subjective idea of musical “genre” for classifying artists and recordings, rather than verifiable facts or events.
Make no evident use of algorithmic analysis in the organization or presentation of the data.
Provide no graphical user interface for navigating relationships.

The website BandToBand.com focuses on relationships between musical groups based on shared members. It offers a simple graphical interface for navigating through musical artists based on these relationships. However, this system:
Takes no account of musical scenes.
Is primarily focused on major label recordings and the artists who produce them. No other types of participants except those directly involved in creating recordings are considered.
Makes no evident use of algorithmic analysis in the organization or presentation of the data.

Songkick focuses on musical events, allowing users to enter information about performances, and create a relationship to performances by indicating what performances a user attended. However, this system:
Takes no account of musical scenes.
Is primarily focused on major label artists rather than local music acts.
Makes no evident use of algorithmic analysis in the organization or presentation of the data.
Provides no graph based user interface for navigating relationships.
Is primarily focused on current and future events, rather than documenting past events.

Australian Music History allows users to record information about artists and musical events. It supports hyperlink navigation across events, venues and artists. However, this system:
Takes no account of musical scenes.
Makes no evident use of algorithmic analysis in the organization or presentation of the data.
Provides no graph based user interface for navigating relationships.

Scene Central on MySpace and The Deli focus on local music scenes. Both attempt to cover multiple music scenes, track musical events, and offer a certain amount of hyperlink based navigation. The Deli employs some algorithmic method for computing a “chart” of local popularity. However, these systems:
Are only focused on musical artists, and take no account of other kinds of participants in a music scene.
Use geographic areas to predetermine the musical “scenes,” and then attach the user generated data to a predefined scene. Unrelated milieus of musical activity are lumped together purely because of geographical proximity.
Are heavily curated by an editorial staff that defines the nature and extent of the scenes.
Make no attempt to identify scenes based on an analysis of user generated content.
Make extensive use of the subjective idea of musical “genre” for classifying artists and recordings, rather than verifiable facts or events.
Provide no graphical user interface for navigating relationships.
Are primarily focused on current and future events, rather than documenting past events.

The Jersey Music, All Western New York, Walla Walla Music, SA Rocks, and Fayetteville NC Music Scene Web Sites are all focused on local music scenes. Most provide lists of venues and local artists. However, all of these systems:
Are only focused on musical artists, and take no account of other kinds of participants in a music scene.
Are only focused on a single, predefined music scene, and take no account of connections between scenes.
Are heavily curated by an editorial staff that defines the nature and extent of the scenes.
Make no attempt to identify scenes based on an analysis of user generated content.
Make no evident use of algorithmic analysis in the organization or presentation of the data.
Provide no graph based user interface for navigating relationships.
Are primarily focused on current and future events, rather than documenting past events.

The above non-limiting description provides examples of the various shortcomings and problems with known cultural scene resources. There are many other differences between the conventional systems described above and the preferred embodiments of the present invention as will be described in more detail below.

### SUMMARY OF THE INVENTION

To overcome the problems described above, preferred embodiments of the present invention provide a system, method, apparatus and computer program for obtaining and analyzing various information relating to a cultural scene, creating a dynamic visual and auditory model of the scene based on algorithmic analysis on one or more relationships between information relating to the scene, and providing an interactive user-experience relating to the scene based on the visual and auditory dynamic model of the scene.

According to a preferred embodiment of the present invention, a method of identifying and presenting information relating to a scene includes the steps of obtaining information relating to a socio-cultural environment based on at least one of an interest, an experience, a physical presence, a relationship or an artistic preference shared by at least two people; analyzing the information obtained in the step of obtaining information so as to identify relationships among the information; identifying a scene based on the step of analyzing the information; and presenting to a user an interactive model of the scene based on the information obtained in the step of obtaining information and analyzed in the step of analyzing the information.

It is preferred that the step of obtaining information includes obtaining information from the user through a user interface.

It is also preferred that the step of obtaining information includes obtaining information from at least one of a storage device, a database, and a computer network.

It is also preferred that the step of analyzing the information obtained in the obtaining step includes using at least one of heuristics and computer algorithms to analyze the information.

It is preferred that the step of identifying a scene includes identifying relationships between the information obtained in the step of obtaining information.

It is further preferred that the interactive model includes nodes and relationships generated based on the information relating to the scene.

It is also preferred that the step of presenting to a user an interactive model of the scene includes presenting to the user information relating to the scene via nodes and relationships.

Other preferred embodiments of the present invention provide an apparatus, a system, and a computer program for performing the steps of the method according to other preferred embodiments of the present invention described above.

The above and other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an illustration of an example of definitions of basic data types for use in a preferred embodiment of the present invention.

FIG. 2 is an illustration of a plurality of nodes and relationships for use in a preferred embodiment of the present invention.

FIG. 3 is an illustration of an expanded example of basic data types and relationships therebetween that are shown in this example as a static two-dimensional graph for use in a preferred embodiment of the present invention.

FIG. 4 is a schematic illustration of a temporal third dimension indicating how the static graph of FIG. 3 can change according to a preferred embodiment of the present invention.

FIG. 5 is an illustration of how geolocation data can be overlaid with core relationship data to produce a resulting scene definition according to a preferred embodiment of the present invention.

FIG. 6 is an illustration of a representation of how atom data can be combined with an affinity graph and geolocation data to produce a more accurate scene definition according to a preferred embodiment of the present invention.

FIG. 7 is an illustration of an example output from a system according to a preferred embodiment of the present invention showing a portion of a real “scene” showing a static graph representing an example subset of relationships between four bands, five members, three venues and three events.

FIG. 8 is an illustration of an example output from a system according to a preferred embodiment of the present invention showing a dense set of paths that are characteristic of a tight-knit local music “scene”.

FIG. 9 is an illustration of an example of a user interface for entering dates with an explicit degree of specificity which models how dates are used in natural language according to a preferred embodiment of the present invention.

### DETAILED DESCRIPTION OF PREFERRED EMBODIMENTS

Various preferred embodiments of the present invention provide a system, method, apparatus and a computer program, (hereinafter referred to collectively as a “system”) a dynamic computer model of a “scene” that can be visual, auditory and/or other sensory-based presentation of the modeled, scene.

In a preferred basic form, according to a preferred embodiment of the present invention, the “scenes” denote voluntary social groupings of individuals who were in geographical proximity at the same period of time and shared experiences based on an affinity to or involvement with a cultural experience. These groupings may preferably be independent of any institution with formal membership, such as a school, company or church congregation (although scenes may include a plurality of members who shared or share such membership).

The concept of a “scene,” especially a scene comprising young people, is immediately familiar to people who have come of age in contemporary Western society, for example. Local youth scenes are a vital rite of passage through adolescence, as children transfer the focus of their social development from their families to their peer groups. Despite their sociological importance, however, scenes' independence from institutional constraints or other firm social, ethnic or geographical boundaries has made quantifying them an elusive task.

Furthermore, scenes are by their nature dynamic: members leave a scene; new members join a scene; and multiple, simultaneous scenes will overlap or converge entirely based on a change of circumstance or a discovery of shared interests. For example, much of the U.S. population will change locations at some point in their lives, including young people relocating for college. These changes add dynamism to the ebb and flow of scenes across geography and time, as families and individuals move and mature.

Conventional computer-based attempts to capture, document, describe or re-create the phenomenon of scenes, as described above, have employed a limited journalistic approach exemplified by blogs, magazines, newsletters or other types of prose-based online publications. Meanwhile, software-based systems that allow an online social network, such as Facebook® or MySpace®, operate dynamically but do not directly address the concept of a scene.

The system according to a preferred embodiment of the present invention is neither a journalistic publication nor a strict social network; instead, it combines elements of both in a unique fashion.

There is no existing system for classifying and maintaining a “scene” or multiple “scenes”, whether related or unrelated, based on socio-cultural information. As noted above, previous attempts are based on a journalistic approach and are generally limited to the prose or article format which does not allow for easy navigation or engaging interaction. A preferred embodiment of the present invention provides a system in which a user is allowed to easily navigate through and interact with all of the elements that comprise a “scene” and also navigate to and interact with other, related scenes.

The conventional journalistic model necessarily asserts a human editorial authority over the process. The writer/editor becomes a curator and historian of the scene. Consequently the definition of “the scene” including those elements that are considered to belong to a scene are left up to the subjective opinion of one or more people.

In contrast, the system according to a preferred embodiment of the present invention determines the constituent elements of the scene through unique algorithmic processes of previously unidentified connections and relationship among specific entities and events relating to a scene, which may be stored in a database or obtained from other sources, and then transforms the computer representation and user interaction with those scenes. Using local popular music as an example, a musical scene would be comprised of the bands, members and fans of those bands, venues where those bands played and individuals experienced the bands' performances, the actual performances themselves, and related media such as posters, for example. The system according to a preferred embodiment of the present invention uses unique algorithms and processes to discern the existence of such scenes by examining the historical data itself and “teasing out” the salient relationships fundamental to a scene. This is in stark contrast to the conventional journalistic approach, which is entirely subjective and usually rests on a preconceived image of the scene in question. This “objective” approach adopted in the preferred embodiments of the present invention is novel and not obvious from approaches taken in the past. Using the previous example as a basis for further discussion, it is the typical case that multiple “scenes” may occupy the same time period and geography, but be virtually unrelated. Therefore, the choice and weighting of the relationship variables is a key unique feature in the automated generation of scene definitions according to preferred embodiments of the present invention. Another unique aspect of various preferred embodiments of the present invention is the step of identifying the relationships which formed the primary connections among various elements of the scene, whereas an after-the-fact editorial approach typically cannot discover or identify such unique relationships.

To cite another example drawn from popular music, the media of the 1990s frequently referred to the “grunge” scene of Seattle. This “grunge” concept was created editorially, in a time and place removed from the events that it sought to label. Almost every single band and member that had been labeled “grunge” by the media vehemently denied that this label applied to them. Nevertheless, most would certainly have agreed that there was a “scene” in Seattle and surrounding environs at the time that the “grunge” movement is supposed to have occurred. Preferred embodiments of the present invention correctly and accurately identify such a scene or scenes in a manner that the participants would themselves recognize, free of an artificially applied editorial slant.

A related but distinct weakness of the conventional journalistic approach is the constricted set of viewpoints used previously. An article has one or perhaps a few authors; a community blog will have a viewpoint that is limited by those who are inclined and motivated to contribute. Accordingly, the system according to a preferred embodiment of the present invention “crowd sources” the source material, providing a low “barrier to entry,” such as the contribution of a single name to the database. The algorithms according to a preferred embodiment of the present invention are then able to “draw” a picture of the scene based on a much wider set of data than the journalistic approach can practically encompass. The system according to a preferred embodiment of the present invention presents the data-entry interface organized as a set of intelligently defined data categories, which are designed to maximize the “atomic” nature of the user-generated content, focusing on single pieces of factual information rather than narrative or opinion. In general, the amount of prose required to input meaningful content is reduced to a practical minimum. This serves the dual purpose of providing a low barrier of entry to those who might not be inclined to compose tracts or spout opinion, while also seeking to minimize the implicit editorial leaning of the user himself. By directing the user to enter “atomic” pieces of factual information, the system according to a preferred embodiment of the present invention analyzes and prepares a “clean” data set in which unique connections and relationships can be identified in the most accurate and unbiased way possible.

The conventional editorial approach also has serious limitations in its ability to scale. Even assuming that a human author could describe a scene with the accuracy and objectivity of the system according to a preferred embodiment of the present invention, the amount of effort involved is massive and would require undue effort and experimentation. Consequently, the conventional journalistic method has only been able to provide descriptions of a small subset of the thousands upon thousands of human cultural milieus that have sprung up throughout history, such as, French Impressionists, Italian Futurists, German Expressionists, Swinging London, Jazz in New York in each phase from the 1930's through the 1960's. This list can certainly go on, but it is unlikely to include an exhaustive survey of Hair Metal bands in 1980s Oklahoma City. To the members of this scene, it was as vibrant and important, and perhaps included as many core members as any of the canonical scenes listed above. However, due to the lack of influence outside of that time and place, this scene has not received the attention needed to document it in any meaningful way. In contrast, the system according to a preferred embodiment of the present invention addresses this failure directly, by using user generated content to create an abundance of source material, software algorithms to perform the analysis which defines the scene in question, and an online, web-based user interface to offer widespread access and easy navigation to both the given and the derived information. The system according to a preferred embodiment of the present invention uses unique algorithms to identify, analyze and utilize previously unrecognizable connections that define a human cultural milieu, and a common set of self-correcting heuristics can be applied to any relevant data set to identify the scene(s) hidden within it.

Conventional systems applying software algorithms to a database of personal connections in order to identify characteristics of a social network is not a novel concept. Social media sites such as Facebook®, Linked-In® and Foursquare®, employ elements of this approach. However, existing systems are focused entirely on current or contemporary events and relationships. In contrast to such conventional systems, the preferred embodiments of the present invention apply social networking concepts to historical data in an entirely novel and unique way that produces unique and unexpected results not possible with conventional systems discussed above. This allows preferred embodiments of the present invention to provide a unique online social networking experience as a “lens” through which to view historical periods and events. No current or conventional systems provide this functionality to their users. The system according to a preferred embodiment of the present invention creates an online view of a social network of the past. This is an especially compelling idea, as membership in a scene is often a defining moment in the life of individuals, which offered a sense of identity and purpose unmatched by the banal, quotidian information that forms the fabric of most existing social media.

Existing online social media focuses on the relationship of “friend”, and/or on geolocation. Academic research into the composition of virtual or actual communities focuses on explicitly “social” connections, primarily acquaintanceship, friendship and kinship. In contrast, the system according to a preferred embodiment of the present invention focuses instead on cultural affinity including interests in and identification with a type of music, art, activity or way of life. This allows social networks to be described which are often quite orthogonal to those which have been previously identified and studied. Neither can existing networks which rely purely on geolocation data satisfactorily address this longfelt and unmet need. Individuals with affinities such as those mentioned above are typically overlaid on geographical space in a complex way. Consequently, social network strategies which focus on geolocation as opposed to personal relationships also fail to recognize these connections.

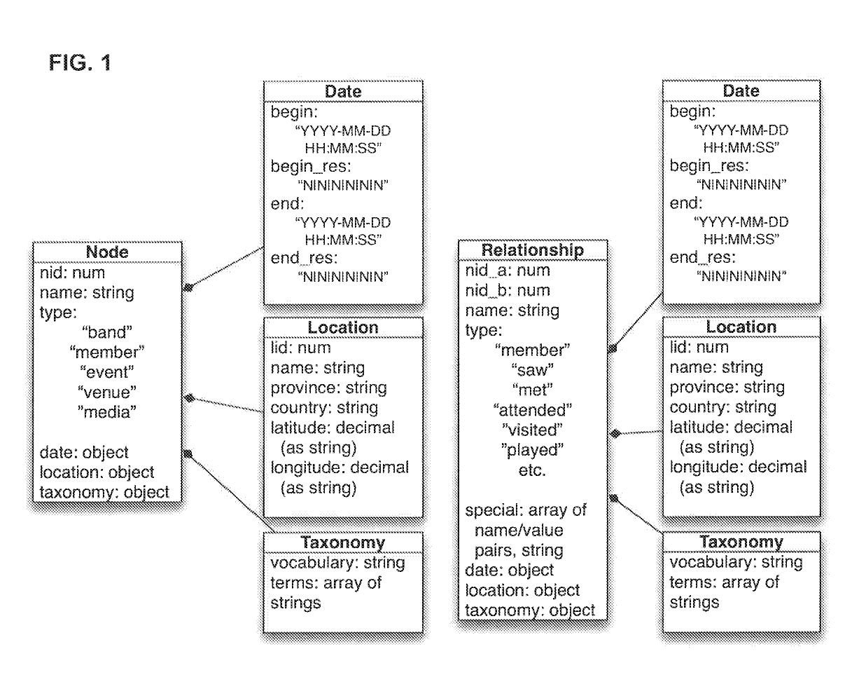

The following provides a description of specific preferred embodiments of the present invention with reference to FIGS. 1-9.

In a preferred embodiment of the present invention, the data that ultimately comprises scenes is stored in a memory storage device such as a standard SQL database, for example. The data is preferably represented in an object oriented fashion, with the core object termed a node. Each node preferably includes a core descriptor, such as a name, and a set of descriptive attributes, many of which are optional. In one example, the core descriptor or name preferably contains a minimal amount of information required to describe a node. Other attributes may include, but are not limited to, time period, geolocation, pseudonyms, or textual description, for example.

The node data structure is preferably built around a “base” node, which preferably includes the following information:

Base Node Definition
Node ID: An identifier that is globally unique within the system.
Name: The name of the entity that this node represents
Type: The node type. This typically represents a single “item”, or an explicitly defined composite item.

The nodes are then connected through a series of relationships inherent to the data structure. Some nodes may be composite in nature, for example, a band or a sports team. The members of these composite entities would be nodes themselves, and links, preferably created by the users or the system, associate the composite nodes with their constituent parts.

Another example of a node and its potential relationships is a piece of media such as a recording of a concert. This media would be represented as an independent node that may have links to other nodes including but not limited to the musical group that performed the concert, the performance at which the concert occurred, the venue in which the performance occurred, the individual musicians who performed it, spectators who were present at the performance, articles or reviews describing the performance, photographs or videos taken of the performance, posters advertising the performance, other renditions of the same musical material, other bands that played at the same event, and recordings of other performances made at the same event, for example.

Each node is defined preferably to be as semantically atomic as is practical for the type of information represented. This allows for the maximum amount of information to be extracted from an analysis of the linkages between the nodes.

The attributes of each base node are augmented by a set of optional descriptors. These are defined as follows:

Date Attribute Definition
Beginning Date: The date and time of an occurrence, or beginning of a time period. Required.
Beginning Date Resolution: The degree of specificity of the beginning date. Required.
End Date: In the case of a time period, the ending date and time. Optional.
End Date Resolution: The degree of specificity of the end date. Required if End Date is set.

The Date object is preferably used to represent both time periods and instantaneous dates. In the case of a time period, both the beginning and end dates are set. In the case of an instantaneous date (for example, the date of an event), only the beginning date is set. The absence of an end date indicates that the date represented is instantaneous.

Date Resolution is a novel concept that is important for representation of historical events in the system according to a preferred embodiment of the present invention. This is preferable in order to model the natural language use of dates as found in historical discourse.

### Software Typically Represents Dates in One of Two Ways:

1. Unix or Posix Time: The number of seconds elapsed since the Coordinated Universal Time (UTC) of midnight, Jan 1 1970.
2. Date Time: YYYY-MM-DD HH:MM:SS, as defined by ISO 8601.

Both date formats implicitly assume that the exact second of an event is known. This assumption is expedient for computational simplicity, but it is entirely inadequate to model the natural language usage of dates in real life. For example, a person may remember that an event occurred “in 1985” but may not have more specific knowledge than the year. To store this information in either of the above formats, without any additional description, incorrectly implies that the exact second of the event is known. This inaccuracy would undermine the quality of the source data. To correct for this, all dates are accompanied by a Date Resolution field, which specifies how precise the date is. This is tied to a novel user interface which allows users to explicitly enter dates with varying degrees of precision.

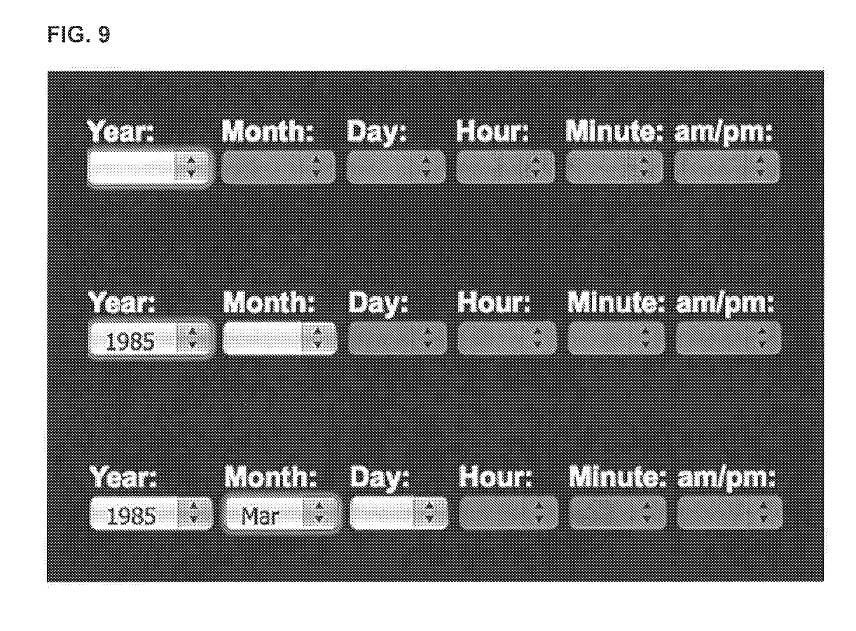

FIG. 9 shows an example of a user interface for collecting user generated date content with explicitly varying degrees of precision.

The following provides examples of Location Definition, Taxonomy Definition, Node Definition, Base Relationship Definition, and Relationship Definition according to a preferred embodiment of the present invention.

The Location Definition Preferably is as Follows:
Location ID: An identifier for this location that is globally unique within the system.
Name: Location name, typically a city or town.
Province: The state or province.
Country: The country or nation.
Latitude: The location's latitude.
Longitude: The location's longitude.

The location structure described above preferably is modeled directly on a subset of the attributes used by popular geolocation services, such as the Google Maps API. The system according to a preferred embodiment of the present invention integrates with a geocoding web service in order to collect and display location information.

The Taxonomy Definition Preferably is as Follows:
Array of name/value pairs: An open-ended set of name/value pairs where the name specifies a specific vocabulary, and the value is one or more terms from that vocabulary.

The array of name/value pairs preferably are used to further define or characterize the entity represented by the node.

The Node Definition Preferably is as Follows:
Node ID: Required
Name: Required
Type: Required
Date: Optional
Location: Optional
Taxonomy: Optional

In addition to the nodes described above, a second data structure is required to define the relationships between the nodes. In classical graph theory, the node above represents a “node”, and the relationship represents an “edge”.

The Base Relationship Definition Preferably is as Follows:
Node ID A: The Node ID for one end of the edge.
Node ID B: The Node ID for the other end of the edge.
Type: An identifier that specifies the nature of the relationship.
Special: Optional list of additional name/value pairs.

In addition to this required core information, Relationships may have the same set of extra information carried by the node, producing the following complete Relationship Definition:
Node ID A: Required
Node ID B: Required
Type: Required
Special: Optional
Date: Optional
Location: Optional
Taxonomy: Optional

FIG. 1 shows the definition of the basic data types in schematic form. The system according to a preferred embodiment of the present invention discovers and identifies many of the subtleties in sociological interaction that characterize a scene. The composition of the Date, Location and Taxonomy objects is often required to capture the full nature of a relationship, distinct from the values that those objects may hold in the nodes themselves.

This data structure can represent directed as well as undirected edges. In the case of a directed edge, Node ID A represents the start and Node ID B represents the end.

The above forms an example of a set of factual information that the algorithms of preferred embodiments of the present invention then operate on to identify the important relationships that comprise a scene. Since the semantic relationships between the maximally atomic nodes are represented as actual linkages between software objects, a computer program may be used to perform this analysis in an automated fashion.

An example of a specific implementation of the system according to a preferred embodiment of the present invention is an application to local popular music “scenes”. The basic node types in this implementation preferably are identified as Bands, Members, Venues, Events and Media, for example.

The data structure definition in the present preferred embodiment of the present invention preferably is as follows:

Node
Node ID: Number
Name: The name of the person, band, venue event or media (string).
Type: “band”, “member”, “event”, “venue” or “media” (string).

Date
Beginning Date: “YYYY-MM-DD HH:MM:SS” (string in MySQL format, subset of ISO 8601).
Beginning Date Resolution: “N|N|N|N|N|N” where “N” is either “0” or “1” (string).
End Date: “YYYY-MM-DD HH:MM:SS”
End Date Resolution: “N|N|N|N|N|N”
   Date Resolutions have the Following Semantics:
year|month|day|hour|minute|second
A “0” means the corresponding component of the date is unknown. A “1” means the corresponding component has been set. For example:
1985-03-21 14:30:00 1|0|0|0|0|0=>“1985”
1985-03-21 14:30:00 1|1|1|1|1|0=>“March 21, 1985 at 2:30 pm”

Location
Location ID: Number
Name: (string)
Province: (string)
Country: (string)
Latitude: Decimal (stored as string)
Longitude: Decimal (stored as string)

Taxonomy

An example taxonomy is one that describes the instruments that a member played in a particular band. This taxonomy would be applied to the relationship between the member and band nodes, for example, as follows:
Vocabulary: “Instruments” (string)
Terms: “Lead Guitar”, “Background Vocals” (array of strings)

Relationship
Node ID A: Number, the Node ID of an existing node.
Node ID B: Number, the Node ID of an existing node.
Type: “Member”, “Sideman”, “Solo Member”, “Guest”, “Crew”, “Staff”, “Management”, “Saw”, “Met”, “Visited”, “Attended”, “Consumed”, “Played” etc. (string)
Special: (string)/(string) e.g. “Replaced”/“Node ID”

The type of relationship that is allowed varies depending on the type of the nodes at each endpoint. A few examples are as follows:
Member→Band: “Member”, “Sideman”, “Solo Member”, “Guest”, “Crew”, “Management”, “Saw”.
Member→Venue: “Staff, “Visited”
Member→Member: “Met”
Band→Event: “Played”
Member→Event: “Attended”
Member→Media: “Staff”, “Consumed”, “Produced”
Event→Venue: “Held at”

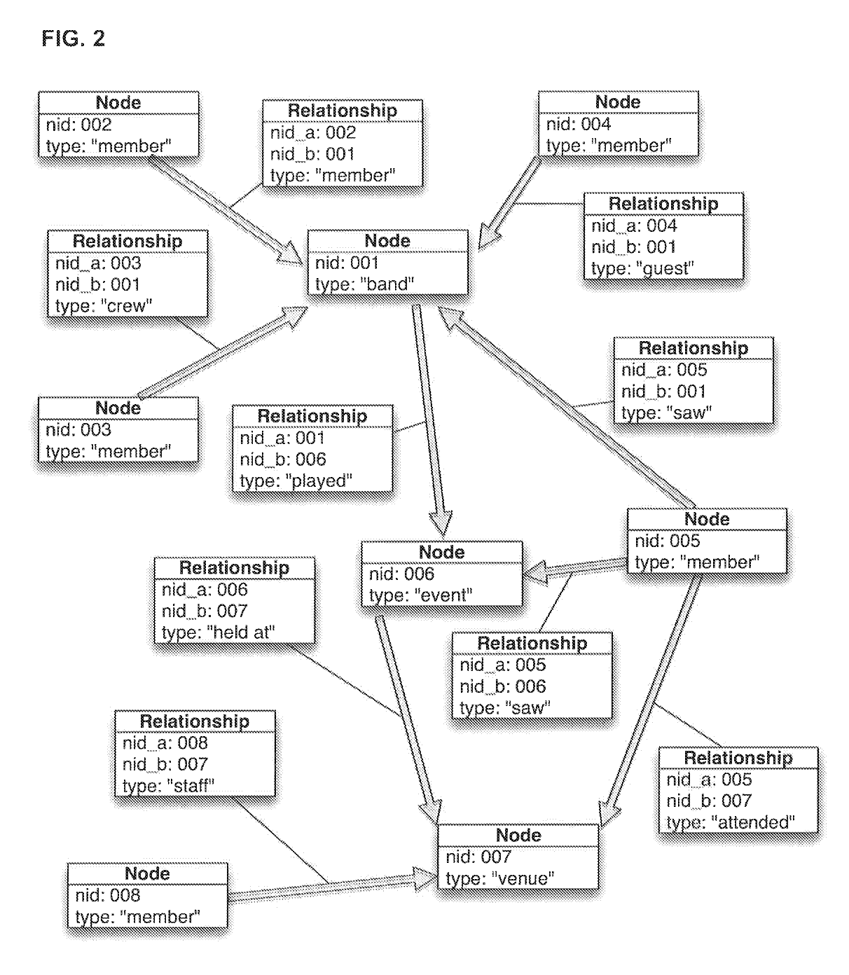

FIG. 2 shows an example of nodes with explicitly defined relationships. One of the novel aspects of preferred embodiments of the present invention is ability to support, identify and analyze multiple types of relationships between various entities. For example, existing systems for describing the relationship between musical acts (bands) focus exclusively on “members”. This allows for the creation of “family trees”, which organize bands based on members held in common. While important, this approach ignores the vital connections that comprise a “scene”. “Saw”, “Met” and “Attended” are key relationships that, when combined with the more standard band “Member” relationship, define the key human interactions that generate the phenomenon of a “scene”.

One of the biggest problems facing social network analysis is that the relationships that systems seek to model are often “fuzzy”, and extremely subjective. This introduces a high degree of arbitrary error into the data that is difficult to account for using mathematical techniques. For example, many social networks are based on the concept of “friend”. This is such a vague and arbitrary term as to be virtually meaningless. The “friendship” between individual A and B could differ in all manner of type and degree vs. the friendship between individuals B and C. Yet, both relationships are classified as “friend”. The very statement “A is a friend of B” is entirely subjective. A and B may even disagree over whether they are friends.

Similarly, social graphs that attempt to model music focus on another set of arbitrary terms (with the exception of the band membership used to define the “family trees”, referred to above). The most common relationships considered are “like”, as in Person A likes Band B, and “genre”, as in Band B belongs to Genre C. Again, both of these concepts are arbitrary and subject to as many different definitions as there are nodes in the graph. The amount of error introduced by the variability in the actual definition of the terms used to create the graph renders any conclusions drawn by analyzing the graph specious at best.

In contrast, a key differentiator between the system according to a preferred embodiment of the present invention and typical social network analysis is that the system according to a preferred embodiment of the present invention considers only factual, well-defined relationships. In essence, each relationship is binary, it is either on or off. Individual A was either a member of Band B or she was not. Individual C either attended a performance of Band D or he did not. Individual E either attended event F or she did not. Band G either played the same show as band H, or they did not. By considering only well-defined, “binary” relationships, the system according to a preferred embodiment of the present invention eliminates and minimizes errors experienced in conventional systems described above. Furthermore, the accuracy with which a scene, such as a musical scene, is defined, is a result of choosing the unique set of binary relationships that are most significant to that definition.

Further, the analysis of the relationships in the social graph over time is not subject to the vagaries of shifting definitions in the system according to a preferred embodiment of the present invention. For example, the ubiquity of Facebook® has changed the very definition of the term “friend”. An individual might “friend” a “real friend”, and the same individual might “friend” someone who is only a “Facebook® friend”. Many people have “Facebook® friends” who are “personal” and others who are “professional”. Any attempt to draw meaningful analysis from this set of ill-defined relationships is hindered from the start by the poor quality of the data set. Attempts to refine the network analysis algorithms over time will be hindered by the continually changing definition of “friend”. The system according to a preferred embodiment of the present invention avoids such problems by using only well-defined relationships. Consequently, the accuracy of definitions of scenes and relationships within the scenes are continuously improved in the system according to a preferred embodiment of the present invention by continuously refining the mathematical algorithms, and by acquiring a larger sample set. The ubiquitous nature of the system according to a preferred embodiment of the present invention cannot change the definition of the relationships it models, as these relationships are not subject to vagueness of interpretation.

The user interface of the website of the system according to a preferred embodiment of the present invention maximizes the ease of data entry. Unlike the journalistic sites which present a user with sections of undifferentiated prose, the interface according to a preferred embodiment of the present invention has previously defined the atomic data types that are of the most interest. Consequently, rather than only providing an open-ended blog-like or wiki-like interface for entering large blocks of text, forms with individual fields that accept small pieces of information, including but not limited to a name, a date, an address or a simple relationship, are provided by the user interface, for example. This facilitates easy data entry requiring a low level of commitment from the user, and it automatically categorizes the information according to type.

The simple data nodes entered by the user are then linked preferably in a one-to-many, many-to-one, and a many-to-many fashion. These links are also formed by the user simply connecting one node in the system to another. The simple nature of the data structure means that it can be easily serialized in a relational database, and easily represented in memory as semantic pointers between individual software objects.

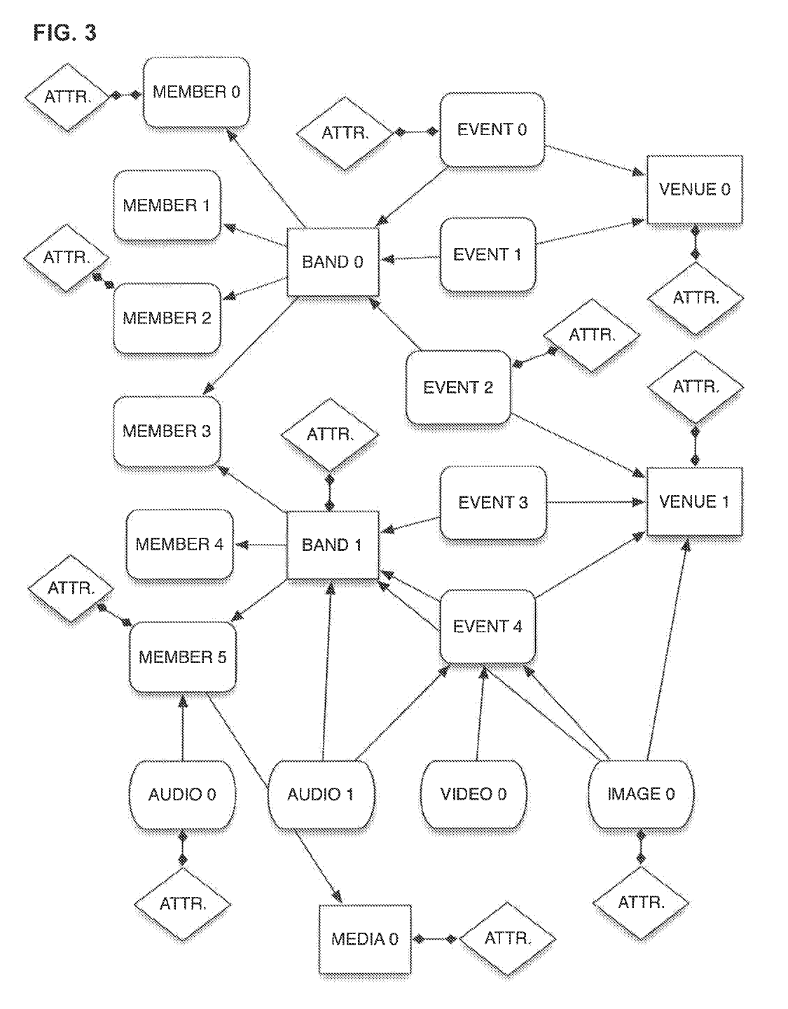

FIG. 3 shows an expanded example of the basic data types and the relationships between them, as a static two-dimensional graph.

The metadata associated with relationships, when available, allows the graph to be traversed in different ways based on relationship type. For example, one traversal could follow band “membership”, while another could follow only those who saw a band perform. The relationship type also allows for edges to be weighted. For example, in the case of the relationship between a band member and a band, the weighting may be as follows:

| Relationship | Weight |
|---|---|
| “Member”, “Solo Member” | 1 |
| “Sideman”, “Guest”, “Crew”, “Management” | .75 |
| “Saw” | .5 |

These weights can then be used to perform computations on the graph using the theory of weighted graphs.

When a relationship has a time period, it does not affect the structure of the static graph. Date metadata is used to model changes over time as a series of temporally related static graphs. This is discussed below. Relationship taxonomy is useful for display and search, but is not used in computations.

Similarly, the node attributes do not affect the structure of the graph but instead are merely metadata attached to nodes. Consequently the structural elements of the data can be modeled as pure nodes and edges, in compliance with classical graph theory.

Thus, excluding the temporal nature of some relationships, the given data can be represented comprehensively as a two-dimensional graph with both directed and undirected edges, where no pair of nodes is connected by more than one adjacent edge. Since disconnected nodes do not provide any relationship information, they are excluded from the core affinity graph, producing a connected graph in accordance with classical graph theory.

Operating first on the two-dimensional graph, that is, the static form of the data representing a single point in time, an example of a comprehensive set of connections will be tabulated as follows:

Allowed Node Relationships
member→band
member→event
member→venue
member→media
member→member
band→event
band→venue
band→media
band→band
event→venue
event→media
venue→media
media→media

Treating each of the above semantic links as an edge, the path lengths between the five fundamental node types—member, band, event, venue and media—can then be examined.

Scenes can also be discovered and identified by using an affinity graph. In a fully connected graph, the characteristic path length (L) is defined as the median of the means of the shortest path lengths connecting each vertex to all other vertices. The following formula calculates L where:
d=Characteristic Path Length
N=Number of nodes in a network
K=Number of links per node

In a real world case, statistical methods are used to approximate L. In particular, the number of nodes is known, but the number of links per node is computed as an average. The Floyd-Warshall algorithm provides a simple and computationally optimized method for finding the set of shortest paths, from which the characteristic path length can be found.

The Clustering Coefficient measures the amount of “clustering” (vs. “evenly spread”) among the nodes and edges in a random graph. The clustering coefficient is defined as follows:
The neighborhood of a node, u, is the set of nodes that are connected to u. If every node in the neighborhood of u is connected to every other node in the neighborhood of u, then the neighborhood of u is complete and will have a clustering coefficient of 1. If no nodes in the neighborhood of u are connected, then the clustering coefficient will be 0.

Latapy (“Main-memory Triangle Computations for Very Large (Sparse(Power-Law)) Graphs,” Theoretical Computer Science, 407, pages 1-3, 2006) provides a computationally efficient solution for determining the clustering coefficient of a random graph.

The system according to a preferred embodiment of the present invention compares the Local Clustering Coefficient for a directed graph:

$${C}_{i} = \frac{\vert \{ {e}_{jk} \} \vert}{{k}_{i} ( {k}_{i} - 1 )} : {v}_{j} , {v}_{k} ∈ {N}_{i} , {e}_{jk} ∈ E .$$

Where v are the vertices, e are the edges and k is the number of connections per node, for neighborhood N.
With the network average clustering coefficient:

$$\overline{C} = \frac{1}{n} {\sum }_{i = 1}^{n} {C}_{i} .$$

Where C is the average of the local clustering coefficient over all neighborhoods.

Given the set of nodes and relationships defined in the system according to a preferred embodiment of the present invention, neighborhoods with a high local clustering coefficient versus that for the network as a whole, are used to identify “scenes”.

Multiple open-source packages are available for computing the characteristic path length of a connected graph in software. The system according to a preferred embodiment of the present invention preferably uses a modified version of the Social Network Analysis Tool which provides PHP implementations for computing both the average path length and the clustering coefficient(s) of a graph.

The method for identifying scenes in the core affinity graph is as follows. First, the set of all nodes that share the same municipality, plus all the nodes without geographic information that are connected to these nodes with a path length of 3 or less, are selected as a starting point. Next, all those nodes of degree 0, i.e. that have no connections, are excluded. By definition, the set of n nodes will form m fully connected graphs, where m<n. Next, all connected graphs with less than 10 nodes are excluded as unlikely candidates to form the nucleus of a scene. Next, the cluster coefficient for each node in the remaining set is calculated. From this, the average cluster coefficient for the set as a whole is calculated. If the sample set is too large to be computed economically, a random subset of the each connected graph can be selected for the computation instead. As this initial set is just the “seed” material for the scene identification process, beginning with a random subset of sufficient size produces no appreciable difference in the results. Once the clustering coefficient for each node has been determined, a percentage of nodes with the highest relative coefficient are selected, for example, those nodes in the top 30%, which group of nodes is referred to as set C. The density of the neighborhoods around these nodes indicates that these nodes are likely candidates to be components of a scene. This group of nodes corresponds to “cliques” in the terminology of social network analysis.

Out of set C, a random starting point is chosen. The type of node is important. In the example of a music scene, this node would be a type of “band”. Then this node is used as the start of a “snowballing” process by iterating through each “played with” relation to find the set of bands that the starting band has played with more than x times, where x is a parameter that can be varied based on sample size. An example starting value of X would be 3. This focus on the “played with” relationship is a unique aspect of the system's data analysis that is key to the identification of sociologically meaningful scenes. Next, the “snowballing” process is initiated again with each new band identified as meeting the contention criterion with the initial band. This process is repeated until one of two states is reached: (1) the set of bands connected by paths to the initial band according to the initial criterion reaches a limit, that is, no more paths meeting the criterion can be found; or (2) the number of bands hits an arbitrary threshold R, where R represents a number of bands that could be expected to belong to the same scene according to sociological evidence. An example value for R would be 20. If the first end state is reached and the number of bands is less than an arbitrary minimum R′, then the value of X can be decremented by 1 and the process repeated. Note that there is no guarantee or expectation that the nodes “discovered” by the snowballing process are members of set C, or even of the original, larger set. Note also that the actual number of times that the bands played together is retained for later use as a weighting for this relationship.

Once the connected set of “played with” has been determined for the starting band, a second “snowballing” sequence is initiated with the same starting band. This time the relationship traced is that of “shared member”. In this case, shared member includes management and crew. The analogous procedure is followed. Starting with the first band, a set of bands that shared or share one or more members with the initial band is identified. Then, each of the bands in this first set is used as a starting point for a new set based on the same criterion. This is continued until the nodes meeting this criterion are exhausted, or the number of bands reaches some arbitrary upper limit R. Finally, a new set is formed by taking the union of the two sets identified above. This connected graph forms the structural core or “skeleton” of a hypothetical scene. Call this set of nodes S₁.

The entire process described in paragraphs [0092] to [0094] is repeated for the next randomly selected node in set C that was not found to be a member of S₁, producing S₂. This process is then repeated for each of the nodes in set C, producing the collection of scene “skeletons” S₁, S₂, . . . Sₙ.

Once the collection S₁, . . . Sₙ. has been identified, each set Sᵢ is “fleshed out” by adding to the skeleton all nodes, from the full set of nodes in the database, that are within degree 1 of the nodes in Sᵢ. Call this new, expanded set Sᵢ′. Each set Sᵢ′ forms a fully connected, static graph, chosen based purely on the recognized connections between the nodes. These sets, S₁′, . . . , Sₙ′, form the “raw” sets of affinity relationships, which will be refined using attribute data attached to the nodes.

The first phase of refinement is accomplished by utilizing the temporal data attached to nodes. It has been observed that sociological scenes will coalesce, fluoresce, and fall apart within a roughly prescribed time period, t. The value of t will vary based on the type of scene being studied. In the case of the music scene example, t is roughly a maximum of 3 years. Using this criterion, bands that are connected to the seed band of Sᵢ′ through the shared member relationship tree are excluded if the starting point of the shared member's tenure falls more than 3 years after the end, or the ending point falls more than 3 years before the beginning, of the member's tenure in the starting band in the chain. In the case where this temporal information is incomplete or unavailable, the connection is given the benefit of the doubt and the node is retained in Sᵢ′. When nodes are excluded in this manner, all other nodes that were members of Sᵢ′ purely through there connection to the excluded node, are excluded as well.

The second phase of refinement uses the available geographic data. In the cases where a node is connected via shared membership, or “played together” at the minimum value of x used to define the relationship, geographic data is examined, if available. If the node connected via the above criteria is found to have a location more than 50 miles, for example, from the seed band of Sᵢ′, the above connections are “cut”. If no other connections remain to Sᵢ′, the node in question, and all nodes that are only part of Sᵢ′ through their connection to this node, are excluded.

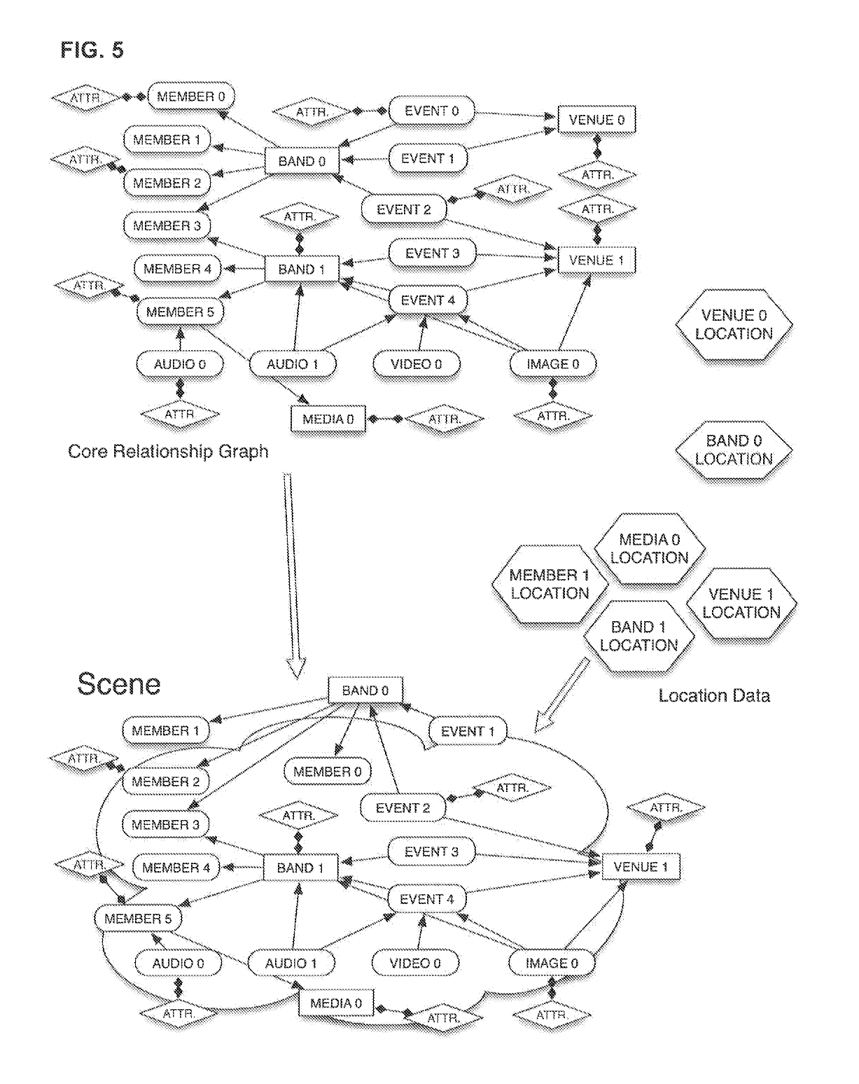

FIG. 5 illustrates a representation of how geolocation can be overlaid with the core relationship data to produce a resulting scene definition.

At this point, S₁′ . . . Sₙ′ are well defined and N scenes have been identified for the rough geographical region centered on the original choice of municipality. There is an important differentiation step in the basic scene definition. It is probable that, using the technique described above, that a given will have “grown” connections to a given Sⱼ′. Some heuristic needs to be used to determine if they are really two “clusters” within the same scene, or two sociologically separate scenes that happen to have overlapping components. The heuristic used is the following: If 2 or more bands shared by both Sᵢ′ and Sⱼ′ have played together 3 or more times, Sᵢ′ and Sⱼ′ are considered to be two parts of the same scene. This is an application of the weighting of the played together relationship that is a unique aspect of the system according to a preferred embodiment of the present invention. If this test is not met, the intersection of Sᵢ′ and Sⱼ′ is taken. If the count of the intersection is 30% or more of the count of the union, Sᵢ′ and Sᵢ′ are considered to be the same scene.

The temporal aspect used above to “weight” scene membership also adds a level of complexity that cannot be reduced to a simple attribute without discarding essential information that cannot be reconstructed. In order to accommodate this, a structural change to the graph itself is required. Deeper consideration of the data types shows that both nodes and edges can have a temporal aspect. Strictly speaking, the temporal aspect of nodes can be reduced to a non-structural attribute. However, on a conceptual level, it is useful to consider time as a third dimension to the graph. At any point in time, the graph can be represented as a two-dimensional graph as defined above. However, the characteristics of this graph change as the graph is observed from different temporal vantage points. This approach contains many elements of interest, and it cannot be represented according to classical graph theory. Thus modern network theory, which was created in order to address just this situation, is required to extract the full amount of information contained in the data.

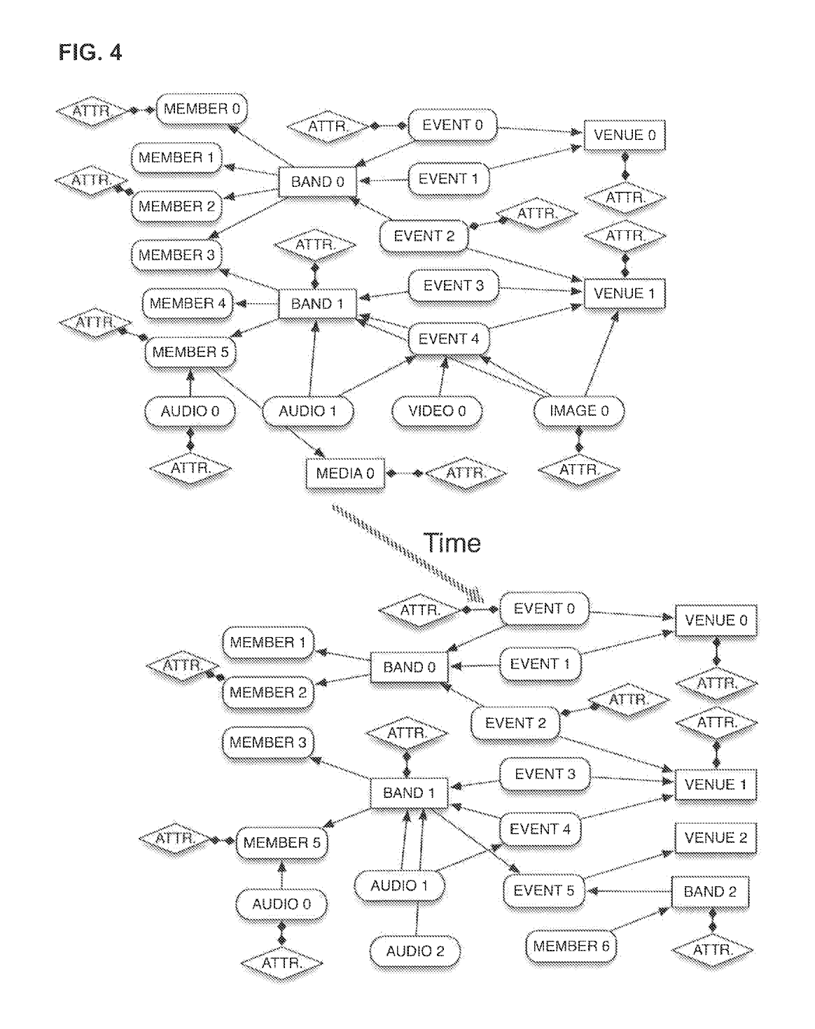

FIG. 4 is a schematic illustration of the temporal third dimension that indicates how the static graph can change.

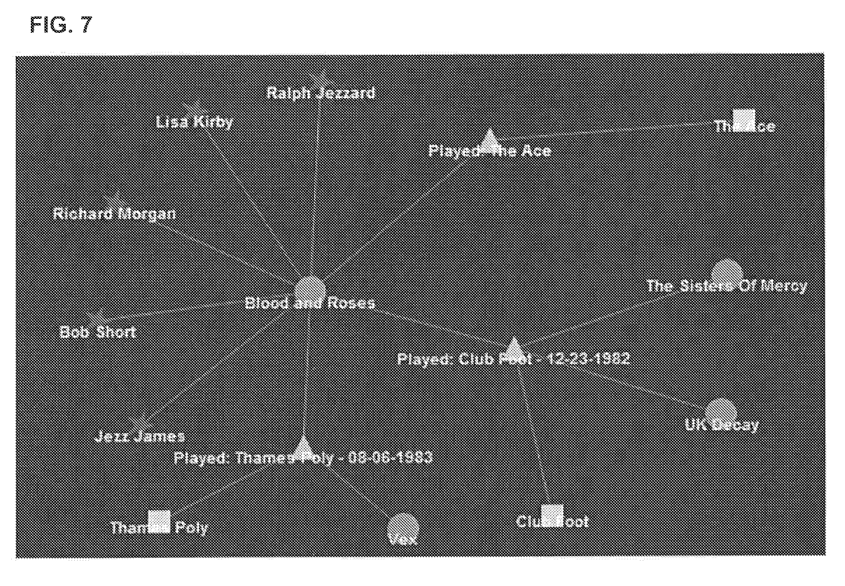

FIG. 7 illustrates a simple example of the system output for the early 1980's London Punk scene as an example. In this user interface, node types are represented by different shapes and colors. The node and relationship types represented in this simple example are:
member—“Member”→band
band—“Played”→event
event—“Held at”→venue

FIG. 7 shows an example of a static graph output from the system according to a preferred embodiment of the present invention.

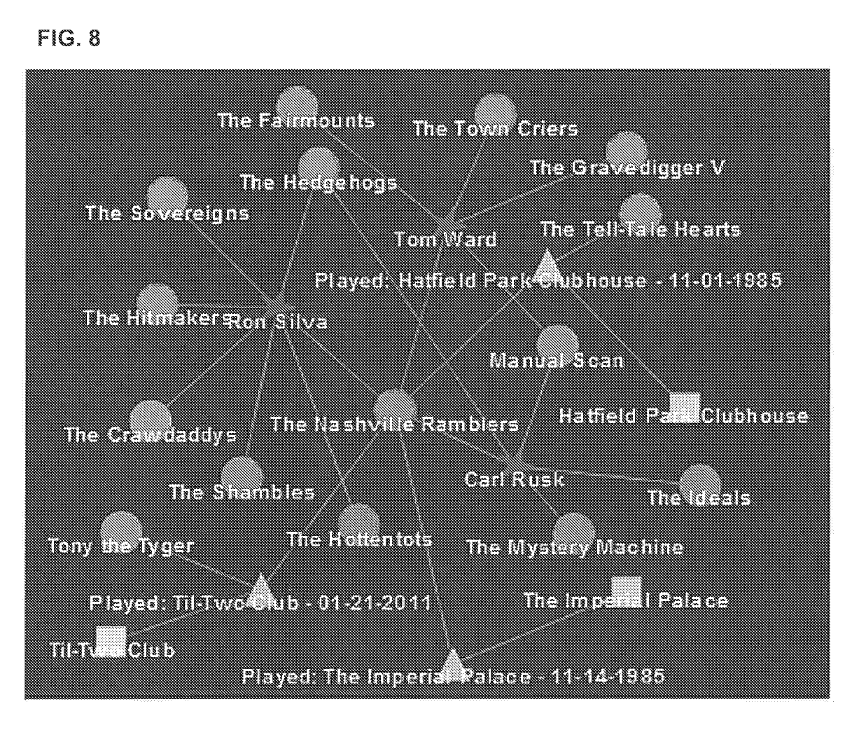

FIG. 8 shows another example of a partial “scene” graph using the San Diego “Garage” music of the mid 1980′s as an example. The scene graph was constructed by the system according to a preferred embodiment of the present invention using the relationships defined above. Paths can be traced through the different relationship types that constitute the core components of the overall “scene” phenomenon. This example illustrates that there can exist a dense set of relationships with a wide variety of paths, and path lengths, through the graph.

The system according to a preferred embodiment of the present invention includes a novel way to incorporate the subjective observations of individual users, referred to as an “atom” and which preferably is a small collection of first class or prioritized node types that a user of the system has chosen to express a combined interest in, experience with or affinity for. Two nodes are considered to be connected based on “opinion” if a particular individual has expressed an affinity for both nodes. This allows for small “atoms” of user defined relationships to be considered as weighting factors for the larger graph. It is expected that the atoms will form a two-dimensional directed graph, where the nodes are a subset of the primary nodes in the main graph, and the edges are created between any nodes that the user has subjectively defined as belonging together. Edges are only allowed in the scene atom graph if 3 or more users have indicated an affinity for the same two nodes. The graph of the atoms is expected to be disconnected, as with the geolocation data, being a semi-random subset of the original graph. But, because each item in the atom set will have an edge to every other item, each atom itself will be a maximally connected graph in its own right. Consequently the clustering coefficient of the entire atom graph will be quite large.

As with the geolocation graph, the atom graph forms a subsidiary set of relationships that can be statistically analyzed using the standard tools for static graphs. Since multiple individuals will be operating on the same dataset, different atoms can and will add greater than one edge between adjacent nodes. This is in contrast to the main graph, where two nodes are either connected, or they are not (only one edge is allowed between adjacent nodes).

Since the definition of scene atoms contains a high degree of subjectivity, they are not used to form affinity graphs on their own because in the system according to a preferred embodiment of the present invention, a reliable definition of a scene is based on objectively defined relationships. However, the atom data can be used to “tune” the results of the pure analysis of factual data. The presence of multiple connections between any two nodes based on opinion, can be used to apply a greater weight to the edge that connects them. So, subjectively defined scene atoms are not used to define relationships in the main affinity graph, but they can be used to weight existing relationships. For example, if a node would be excluded from a set Sᵢ′ based on the criteria described above, the exclusion could be skipped if there is a strongly weighted connection in the opinion graph. If, to continue the example, a band b was found to fall outside the geographical region of the majority of the scene, but there were 6 links between the band in question and other nodes in Sᵢ′ in the “opinion” graph, then the node b would be retained in Sᵢ′.

By collecting numerous “atoms” of subjective opinion, and then subjecting them to the analysis described above, the “inaccurate” opinions will be canceled, while the “accurate” opinions will reinforce each other. In this way, the system according to a preferred embodiment of the present invention is able to take advantage of the subjective experience of its user base without being unduly swayed by the editorial slant of any one individual. This allows the system according to a preferred embodiment of the present invention to produce results, such as mapping relationships between components of a scene, which are significantly more accurate than any existing approach.

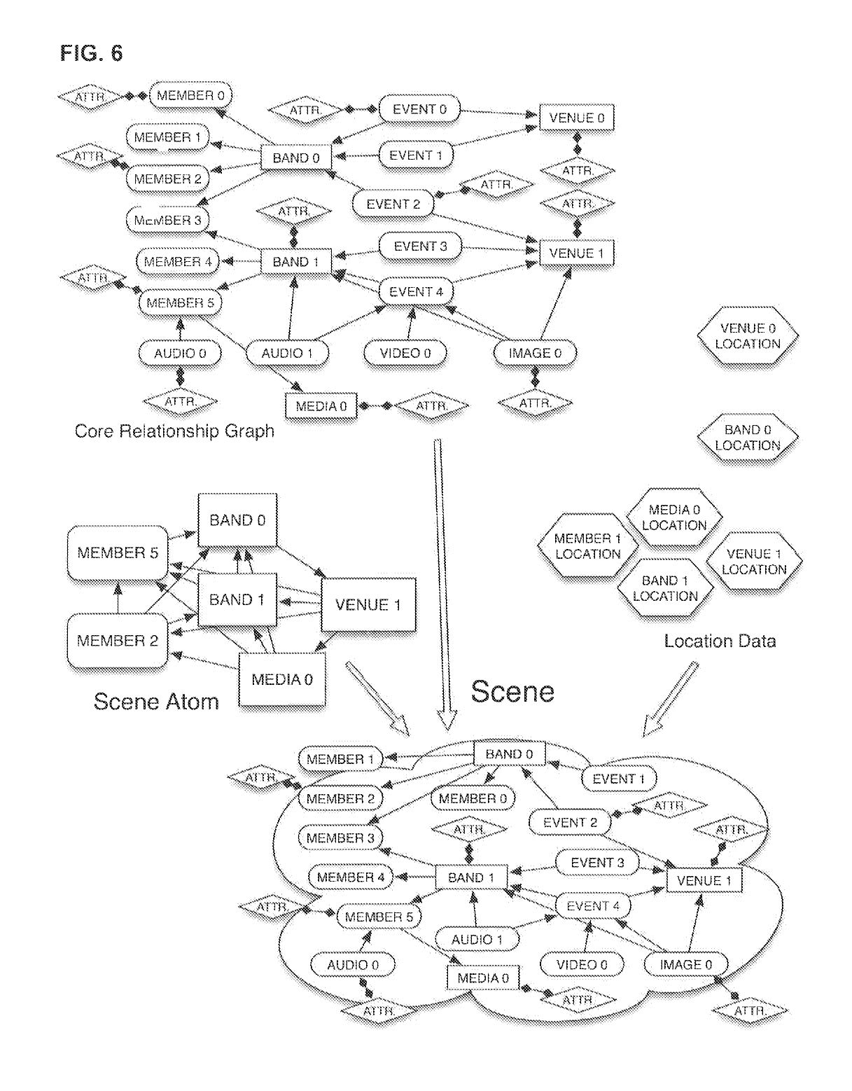

FIG. 6 illustrates a representation of how the atom data can be combined with the affinity graph and the geolocation data to produce a more accurate scene definition.

It is expected that the borders of scenes will be “fuzzy” with statistical methods used to essentially determine the probability that any given node will belong to the scene in question. For example, nodes with strong proximity but weaker affinity, as well as nodes with no location data but moderate affinity, will form “outliers”. Similarly, nodes with connections established by a low number of atoms will tend to fall towards the outside edges of the scene, as opposed to nodes whose relationship has been verified by multiple atoms with overlapping “opinions”.

It is not expected, however, that the edges of the scenes will blur into each other in a wholly indistinct (i.e. random) fashion. The overall affinity graph has a high cluster coefficient, meaning most nodes will belong to neighborhoods where the characteristic path length is considerably shorter than that for the graph as a whole. Using this fact, nodes can be assigned degrees of membership in a given scene by ranking the probability that any node belongs to a given scene. With this ranking data, an abstract “center of gravity” can be computed which represents the theoretical center of the scene, which may or may not correspond to an actual node present in the system.

Meanwhile, these scenes are preferably connected by shortcuts. A shortcut is a path between two scenes that are significantly shorter than the average path length between any two nodes in the respective scenes. Once the nodes in two disparate scenes have been defined, shortcuts can easily be identified by looking for path lengths between any two nodes in the respective scenes that can be shown to be shorter than the average path length between all of the nodes that connect them. These shortcuts form significant connections between disparate scenes, allowing the “meta” relationship between scenes to be determined.

Another important aspect of scenes that can be ascertained by examining path length is the location of the “stars” of the scene. In social network theory, stars are those nodes that have a high degree and tend to form the “bridge” through which other nodes are connected. Stars can be identified in each scene by computing the average path length between all nodes in the scene set, Sᵢ′. The stars would be those nodes that have the shortest average path length within the scene in question. An arbitrary cut-off can be chosen, for example, the top 5% with the shortest path length. This technique will frequently identify “stars” among scene participants who were not band members, but were in fact in the “thick” of the scene's activity. This identification of key figures in the scene that are not strictly “artists” is another novel aspect of the system according to a preferred embodiment of the present invention.

Once the static relationships have been identified, the following information is provided by the system according to a preferred embodiment of the present invention for any point in time:
The ranking of a node's membership in a given scene, based on its probability of belonging to a neighborhood cluster.
The paths, especially the shortest path, that connect a given node to the theoretical center of gravity of that scene.
The shortest distance between the theoretical center of gravity of any two scenes.
The paths, especially the shortest path, that connect the center of gravity of any two scenes.

Existing technical solutions fail to offer the following unique and advantageous results, which the system according to preferred embodiments of the present invention achieves.

For example, preferred embodiments of the present invention automatically discover, identify and document scenes using data mining and heuristic analysis.

In addition, preferred embodiments of the present invention provide dynamic scalability not possible with existing software systems that address the “scene” concept based on the conventional journalistic model, which require a human author to edit and curate. The system according to a preferred embodiment of the present invention, being automatic and based in software, can scale indefinitely provided that user-generated content is continually added to the database, and that storage, memory and processing power are expanded accordingly.

In addition, existing social networking systems operate on current information, or at most on “contemporary” information that extends only as far back as the launch of the system. The system according to a preferred embodiment of the present invention is specifically designed to track the nature and extent of social networks through time and is explicitly based on historic data. As such, it is the only system that models, facilitates, tracks, and reports on social networks that existed in the past but may not still exist during the lifetime of the system itself.

Using the analysis outlined above, a user interface is generated and presents the contents of the database in a number of meaningful ways that are not available using existing software systems. In addition, the data in the system according to a preferred embodiment of the present invention can be provided to other sites as a web service.

The system according to a preferred embodiment of the present invention provides the following features:
a) A representation of an entire “scene” can be created, showing the constituent elements of the scene in a textual and/or graphical fashion, with navigation between the elements of the scene according to the actual pathways in the original graph.
b) A single node can be selected as the focus. The user interface can then represent how this node fits into a scene or scenes, again providing navigation that corresponds to the pathways in the abstract graph.
c) Both a and b above describe views of the static graph at a specific moment in time. Using this as a basis, the data from the temporal axis can be applied, allowing a user interface that shows dynamic changes to the static graphs as the focus is shifted through the temporal axis. This would allow the user to “scroll” or “travel” through a timeline of shifting semantic relationships.
d) The computed results add a rich semantic layer to the core factual data. This data can be made available via standard web service interfaces to other web sites or mobile applications. This can be used to provide a number of enhanced features not available using existing technologies, such as scene based browsing, scene based navigation, and historically contextualized metadata.
e) Temporal navigation and context can be provided for sites or applications that have no source for dynamic temporal placement.

The system according to a preferred embodiment of the present invention is not obvious for a number of reasons. Chief among these is the insight to use scenes as the organizing principle through which to analyze and represent any of socio-cultural data. This novel and unique approach combines special knowledge, experience and information from such diverse and non-analogous fields including journalism, mathematics, and local music. The concept of applying the organizational principle of the scene to user generated content is also unique and non-obvious.

Conventional systems have attempted to apply graph theory and network science to social networks, but prior attempts focus on the relationships loosely defined as “friendship” or “kinship”. In contrast, the unique application of the algorithmic analyses to social relationships based on the specific set of cultural and geographic relationships employed by the system according to a preferred embodiment of the present invention is not obvious.

Similarly, conventional social networking software systems are universally concerned with contemporary events and relationships. The idea of applying techniques from social network analysis to historical data that existed prior to the inception of the system according to a preferred embodiment of the present invention, the concept of identifying historical social networks using software, and the idea to track the evolution of historical networks through time all included in various preferred embodiments of the present invention are also far from obvious.

In addition to the above, the system according to a preferred embodiment of the present invention offers a solution for organizing vast amounts of socio-cultural data in a meaningful and accessible way. This method is superior to existing systems because it possesses the following qualities.

The system according to a preferred embodiment of the present invention is designed a priori to detect and describe scenes, an important socio-cultural phenomenon that has never been the subject of a large-scale software based offering.

The system according to a preferred embodiment of the present invention stores and processes small bits of information that can be easily input by an individual without any special skill set. This allows the information base of the system to include the knowledge and recollection of thousands of participants, rather than the few dozen at most who might contribute to a journalistic treatment of the same subject matter.

The system according to a preferred embodiment of the present invention is able to accurately identify scenes. By focusing on specific historical facts, choosing the proper relationships and analyzing them appropriately, the system according to a preferred embodiment of the present invention can define scenes free of editorial slant or subjective interpretation. For example, in the music scene example, a much wider range of historically accurate and factually correct relationship types are preferably used as compared to conventional systems. In the music scene example, band members, management, crew, guests, and people who saw the band perform are preferably used. Further, bands that played together, how many times the specific bands played together, and other relevant historical facts are collected and preferably used. In addition, information relating to staff and visitors at venues, and attendees at gigs are also preferably used. Information about media (recordings, publications, etc.), who created such media, who consumed such media, what other entities (e.g., bands) that these media were connected to, etc., are also preferably used by the system according to a preferred embodiment of the present invention. Although a conventional system may allow a user to indicate a personal historical fact, such as the fact that a particular user attended a band performance, such conventional systems do not allow for input and use of any historical facts relating to others, such as the fact that someone else attended the same band performance. In contrast, the system according to a preferred embodiment of the present invention enables the user or users to input and use any factual relationship information about themselves or any other person, living or dead.

The system according to a preferred embodiment of the present invention is based on an analysis of relationships that are unambiguously defined. The definition of these relationships will not change over time, and the ubiquity of the system according to a preferred embodiment of the present invention cannot change the definition of the terms that it uses in its model. Consequently, the results of analysis performed by the system according to a preferred embodiment of the present invention will not inherently degrade over time, and the accuracy can be improved through constant refinement, without being undermined by the decay of the definitions upon which it is based.

An implementation of the system according to a preferred embodiment of the present invention can be built using standard open source technology. PHP, MySQL, Drupal, HTML, CSS and JavaScript are the only technologies required, all of which are free. The system then scales without direct human editorial control. In the journalistic model, the number of authors and editors would have to increase linearly with the number of scenes covered.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A method of idenifying and presenting information relating to a scene, the method comprising the steps of:
obtaining information relating to a socio-cultural environment based on at least one of an interest, an experience, a physical presence, a relationship or an artistic preference shared by at least two people;
analyzing the information obtained in the step of obtaining information so as to identify relationships among the information;
identifying a scene based on the step of analyzing the information; and
presenting to a user an interactive model of the scene based on the information obtained in the step of obtaining information and analyzed in the step of analyzing the information.

2. The method according to claim 1, wherein the step of obtaining information includes obtaining information from the user through a user interface.

3. The method according to claim 1, wherein the step of obtaining information includes obtaining information from at least one of a storage device, a database, and a computer network.

4. The method according to claim 1, wherein the step of analyzing the information obtained in the obtaining step includes using at least one of heuristics and computer algorithms to analyze the information.

5. The method according to claim 1, wherein the step of identifying a scene includes identifying relationships between the information obtained in the step of obtaining information.

6. The method according to claim 1, wherein the interactive model includes nodes and relationships generated based on the information relating to the scene.

7. The method according to claim 6, wherein the step of presenting to a user an interactive model of the scene includes presenting to the user information relating to the scene via nodes and relationships.

8. A non-transitory digital storage medium comprising a computer p for performing a method of identifying and presenting information relating to a scene, the method comprising the steps of:
obtaining information relating to a socio-cultural environment based on at least one of an interest, an experience, a physical presence, a relationship or an artistic preference shared by at least two people;
analyzing the information obtained in the step of obtaining information so as to identify relationships among the information;
identifying a scene based on the step of analyzing the information; and
presenting to a user an interactive model of the scene based on the information obtained in the step of obtaining information and analyzed in the step of analyzing the information.
